(19) United States
(12) Patent Application Publication
(10) Pub. No.: US 2003/0144823 A1
(43) Pub. Date: Jul. 31, 2003

(54) Scale-free network inference methods

(76) Inventors: Jeffrey J. Fox, Ithaca, NY (US); Colin Hill, Ithaca, NY (US); Vipul Periwal, New City, NY (US)

Correspondence Address: ROPES & GRAY LLP, ONE INTERNATIONAL PLACE, BOSTON, MA, 02110-2624, US

(21) Appl. No.: 10/286,372

(22) Filed: Nov. 1, 2002

Related U.S. Application Data
(60) Provisional application No. 60/344,527, filed on Nov. 1, 2001.

(51) Int. Cl. G06G 7/48; G06G 7/58

(52) U.S. Cl. 703/11

(57) ABSTRACT

Presently disclosed are methods for inferring a network model of the interactions of biological molecules and systems for practicing such methods. The systems and methods described herein provide a systematic and computationally feasible solution to the problem of rational inference of the architecture of biological networks, based on a combination of rational and statistical evaluations of quantitative and qualitative data. These methods constrain the search space of possible networks and, in some embodiments, allow the online addition of new data into an existing model without any interruption in analysis. Additionally, these methods can provide a quantitative evaluation of the confidence levels associated with the putative network architectures discovered thereby. The methods naturally incorporate latent nodes in the search space of possible architectures; hence, the system is also capable of predicting new interactions and/or substrates for the biological systems being studied.

### CROSS-REFERENCE TO RELATED APPLICATIONS

This application claims priority to U.S. Provisional patent application Ser. No. 60/344,527, filed on Nov. 1, 2001, hereby incorporated herein by reference in its entirety.

### BACKGROUND OF THE INVENTION

1. Field of the Invention

The disclosed invention relates to bioinformatic methods and systems, specifically to network modeling and simulation of cellular functions.

2. Description of the Related Art

The space of possible biological system networks for n species of interacting molecules increases factorially in the number of species. As such, there is no known, rational, probabilistic search strategy that can adequately sample the space of networks to infer the correct architecture of a dynamical system that can simulate the time, course, and other forms (possibly including qualitative forms) of experimental biological data. There is, in addition, the serious problem of an inadequate amount of data given the vast number of possible network architectures and the corresponding high-dimensional space of possible kinetic coefficients and initial conditions.

Accordingly, what is needed is a search strategy that reduces the network search space down to a smaller space that can then be sampled probabilistically to identify candidate architectures for computer simulation of the biological system.

### SUMMARY

Presently disclosed are methods for inferring a network model of the interactions of biological molecules that are involved in the functioning of life forms and systems for practicing such methods. The network to be inferred involves the interactions of proteins with other proteins, the interactions of proteins with nuclear DNA, the expression and translation into proteins of mRNA, the actions of enzymes, and the combinatoric control of gene expression. The systems and methods described herein provide a systematic and computationally feasible solution to the problem of rational inference of the architecture of biological networks. These methods are based on a combination of rational and statistical evaluations of quantitative and qualitative data, together and separately. These methods constrain the search space of possible biological interaction networks and, in some embodiments, allow the online addition of new data into an existing model without any interruption in analysis. Additionally, these methods and systems can automatically provide a concrete, quantitative evaluation of the confidence levels associated with the putative network architectures discovered thereby. The methods presently disclosed naturally incorporate latent nodes in the search space of possible architectures; hence, the system is also capable of predicting new interactions and/or substrates for the biological system or systems being studied.

### BRIEF DESCRIPTION OF THE DRAWINGS

The present disclosure may be better understood and its numerous features and advantages made apparent to those skilled in the art by referencing the accompanying drawings.

FIG. 1A is a histogram of the mammalian cell cycle derived from the Kohn Map.

FIG. 1B is the data of FIG. 1 a plotted in log-log format.

FIG. 2 shows the theoretically obtained critical value of bias p as a function of the mean number of inputs Kₘₑₐₙ.

FIGS. 3A and 3B show the fraction of disordered (period >1500) networks as a function of p for K=4 and 6 and N=100.

FIGS. 4A, 4B, and 4C show the fraction of active, or unfrozen, elements in a network as a function of bias p for K=2, 4, and 6 and N=100

FIG. 5 shows the lower bound of the fraction of frozen elements in power law networks as a function of the exponent beta in the power law with a bias p=0.5.

FIG. 6 is schematic of four types of node classifications, according to one embodiment of the present invention.

FIG. 7 is flowchart of a network inference process, according to one embodiment of the present invention.

### The use of the same reference symbols in different drawings indicates similar or identical items.

### DETAILED DESCRIPTION

Introduction

Presently disclosed is a search method that reduces a network search space down to a smaller space that can then be sampled probabilistically with the aim of finding the right network architecture for a computer simulation of a biological system. It allows the inference of latent nodes and interactions, thereby predicting the existence of certain interactions that may then be experimentally confirmed.

This network inference technique, in its general form, is used to fill in the unknowns of a network model of a biological system based on various observed or real world data. This observed data includes experimental data, observations in vivo, observations based on desired network robustness or bioinformatic predictions, etc. In fact, the data that is used to fill in the unknowns is actually “all that is known” about the biologic system, including all that is known with some non-unity confidence interval, i.e., observations that are only true with a certain probability. The resulting ensemble of candidates, which is also referred to as a Bayesian ensemble, is then used as a whole to make predictions of biological system performance.

The ensemble tests hypotheses of biologic activity but in a computationally realistic manner. This is necessary because, in reality, there are thousands of possible interactions, inputs, and outputs to the biological system. The potential for thousands of inputs and outputs can result in 2¹⁰⁰⁰⁺ combinatoric hypotheticals. Checking that many hypothetical models in an exhaustive sense is computationally impossible.

The foundation of the present method is the discovery that the topology of a biochemical network profoundly influences the behavior of that network. In particular, the relationship between network topology and behavior can be discerned at least in part by the degree of order actually present in the network. Recent analysis (described below) has shown that for a large class of networks that have been used over the past three decades to study the regulation of gene networks (a term construed here to include the interactions of the genes, the proteins they are translated into, the post-translational modifications of the proteins, and other molecules of biological relevance), finite scale-free networks are more ordered than other types of networks such as delta function networks and Poisson networks. Thus, the topology of scale-free networks, characterized by a wide distribution in the number of inputs per element, can actually provide a source of ordered dynamics in biological systems. At the same time, it is also well-known to those skilled in the art that the generic dynamical system is chaotic in its behavior. The search strategy for the inference of possible architectures for biological systems is thus biased by an a priori distribution, such as a Bayesian prior, on the space of models that favors models with scale-free architectures. The resulting bias-reduced search space and the scale-free network optimization may then be implemented with a practical search algorithm in order to realize the desired reduced-space search. Some possible embodiments of such a search algorithm are further described below.

An important factor in scale-free prior design is the fact that the power of the power law which governs the network architecture is initially unknown: any search strategy used must find a cost function that does not require a priori knowledge of the power of the power law distribution governing the network. Two examples of such a cost function, which can be readily generalized by one of ordinary skill in the art without undue experimentation while preserving the essential property mentioned above, may be described as follows:

Let N(k) be the number of species of molecules that have k connections to other species of molecules in the biochemical network, A is a positive real number (the power in the power law distribution), and C is a positive real constant. Observe that if one defines a quantity:

$${x}_{p , q} = \frac{N ( p ) N ( q )}{N ( pq )}$$

where p and q are positive integers, then the function S defined by:

$$S = {\sum }_{p , q} {{R}_{p , q} ( {x}_{p , q} + \frac{1}{{x}_{p , q}} - Q - \frac{1}{Q} )}^{2}$$

(where Q=Average value of {x_{p,q}} and R_{p,q} are positive real constants) is positive semi-definite and only vanishes when Nₖ=Ck^{-A}, where A is the power of the power law distribution and C is a positive real number. If any of N(p), N(q) or N(pq) vanishes for some value of p or q, the corresponding term(s) in S is(are) be replaced by a positive number (e.g., 1), or the value of R_{p,q} is set to vanish for these terms.

Notice that the function S does not assume the value of A. The minimization of S in the search over network topologies will lead exactly to networks with scale-free distributions of links between elements. Observe also that the positive real constants R_{p,q} can be taken to be an arbitrary function of p and q, including the simplest form R_{p,q}=1. Any arbitrary monotonic positive semi-definite function of

$${x}_{p , q} + \frac{1}{{x}_{p , q}} - Q - \frac{1}{Q}$$

can also be used in this definition, including different functions for different values of p and q. An alternative cost function S can also be given:

$$S = {\sum }_{p} {B}_{p} {\sum }_{m \vert p} ( {y}_{p , m} + \frac{1}{{y}_{p , m}} - 2 )$$

where the inner sum is over integers m that divide p, and

$${y}_{p , m} = \frac{N ( p / m ) N ( pm )}{{N ( p )}^{2}}$$

If any of N(p), N(m) or N(p/m) vanishes for some value of p or m, the corresponding term(s) in S is(are) be replaced by a positive number, or the value of Bₚ is set to vanish for these terms.

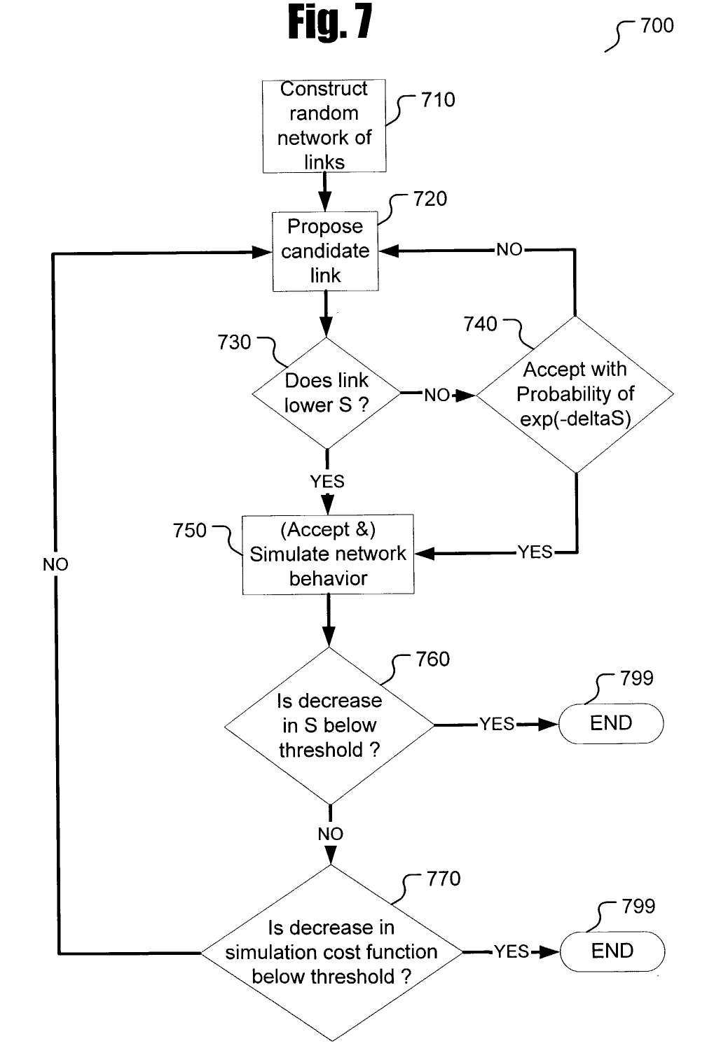

With such functions S in hand, the steps required to perform the network inference are as follows, described with reference to FIG. 7:

1. Construct a random network of links, 710, consistent with known concrete biological data.

2. Propose a new a link to the network (step 720), accepting the new link if it lowers the value of S (test 730). Alternately (step 740), accept the link with probability exp (−ΔS) if S increases, where ΔS (deltaS) is the change in S upon adding the link to the network.

3. Simulate the behavior of the network 750 to find optimal values of network parameters such that the network reproduces qualitatively or quantitatively known quantitative or qualitative biological experimental information, using a simulation platform such as the E-Cell, A-Cell, or M-Cell cell biology simulations, which are well-known research tools currently in use today. Alternatively, publicly available software packages that simulate systems of differential equations (as in the field of non-linear dynamics) may be used, since the underlying equations describing such networks are in fact differential equations. Examples of suitable differential equation system simulations are Content (by Dynamical System Software) and DsTool, the Dynamical Systems Toolkit, available from the Center for Applied Mathematics at Cornell University, http://www.cam.cornell.edu.

4. Go back to step 720 until either:

a) the decrease in S is below a certain threshold set by (for example) a small percentage of the magnitude of S (test 760); or

b) the decrease in the simulation cost function as implemented in a simulation platform is below a certain threshold (test 770) determined by (for example) the uncertainty in the experimental cell information available. (In other words, if either of tests 760 or 770 are true, end at step 799.)

The output of this algorithm is a set of scale-free networks which reproduces the experimental data. New nodes in these inferred networks can then be tested in independent biological experiments, either on a network-by-network basis or on all the networks in the set, which may be further refined by other analysis.

Modeling

The present invention is a method of constraining the number of hypothetical networks that represent a biological system with a certain confidence. This constrained set, the Bayesian ensemble (taken as a whole), is by definition a robust predictor of the biologic behavior.

Abstract formulations of the regulation of gene expression as random Boolean switching networks have been studied extensively over the past three decades. These models have been developed to make statistical predictions of the types of dynamics observed in biological networks based on network topology and interaction bias, p. For values of mean connectivity chosen to correspond to real biological networks, these models predict disordered dynamics. However, chaotic dynamics seems to be absent from the functioning of a normal cell. While these models use a fixed number of inputs for each element in the network, recent experimental evidence suggests that several biological networks have distributions in connectivity. We therefore study randomly constructed Boolean networks with distributions in the number of inputs, K, to each element. We study three distributions: delta function, Poisson, and power law (scale-free). We analytically show that the critical value of the interaction bias parameter, p, above which steady state behavior is observed, is independent of the distribution in the limit of the number of elements N−>∞. We also study these networks numerically. Using three different measures, (types of attractors, fraction of elements that are active, and length of period), we show that finite, scale-free networks are more ordered than either the Poisson or delta function networks below the critical point. Thus the topology of scale-free biochemical networks, characterized by a wide distribution in the number of inputs per element, may provide a source of order in living cells.

Abstract models of gene regulation networks suggest that real cells should display chaotic dynamics. Experimental evidence suggests otherwise. We propose that a distributed connectivity, shown to have profound effects in other complex networks, may be the source of order in the biochemical circuits that control cellular behavior.

Introduction

The human genome has now been sequenced and many other genome sequencing projects are nearing completion. Concurrently, methods to identify protein-protein interactions,¹ as well as trans-acting regulatory proteins and cis-acting regulatory binding sites on a genome-wide scale are being developed.^{2,3} [Note that the superscripted numerals refer to reference material listed at the end of this section.] Thus, the complete topology of gene expression networks and signal transduction pathways that control cellular behavior is beginning to materialize. What is the significance of this topology to the functioning of a cell? Cellular function depends on the dynamics of the MRNA and protein concentrations that comprise the biochemical networks that make up a cell. Thus, understanding the relationship between the topology of these biochemical networks and their dynamics may provide some insight into the regulatory organization found in biochemical networks.

The relationship between topology and the dynamical states of large biological networks has been studied using abstract randomly constructed Boolean networks.⁴ These networks are characterized by a fixed number of inputs, K, per element and an interaction bias p.⁴ While this formulation has obvious limitations compared to models with more realistic representations of the chemical kinetics, a number of results have been shown to be robust in the transition to the more realistic piecewise linear and nonlinear equation formulation.⁵⁻⁷ While Bagley and Glass showed that some attractors in the Boolean switching network models are artifacts of the synchronous updating and discretization of state space and time, the classification of the dynamical attractors of particular networks were shown to remain invariant in the piecewise linear and nonlinear equations.⁶ Also, it is the only framework in which large-scale statistical properties can be studied readily. It was shown by Kauffman⁴ that increasing the number of inputs per element pushed the system through a transition from steady state dynamics to periodic and finally to “disordered” dynamics in which the length of the cycle grows exponentially with the number of elements in the system. For an equal distribution of “on” and “off” states for the activity of an element (p=0.5), the transition is predicted to occur at two inputs per element.

Recent experimental work suggests that the number of inputs per element in real biochemical networks is greater than two, leading to a prediction of “disorder” or chaotic dynamics in cells. However, this prediction does not agree with experimental observations. The biological processes studied thus far can be classified into the following dynamical states: those displaying fixed point behavior such as the lac Operon in E. coli,⁸ and those with periodic dynamics such as the mammalian cell cycle, circadian rhythms in Drosophila, the Glycolysis pathway, and Ca2+ signaling.⁹ Chaotic dynamics seems to be absent from the fundamental dynamical states of a normal cell.

The dynamics of cellular systems may depend on the connectivity of the underlying biochemical circuits. Recent research has begun to elucidate the topology of real cellular networks. This effort has lead to the discovery of several examples of cellular networks that have a mean number of inputs larger than the critical value of two and that are characterized by wide distributions in connectivity. As evidence of distributed connectivity in real biochemical circuits, we cite three examples: metabolic networks,¹⁰ yeast protein-protein interaction networks,¹ and mammalian cell cycle networks.¹¹

Jeong, et al.,¹⁰ did an extensive study of metabolic networks in 43 different organisms. They found that all of these networks had power law distributions, with an average exponent of 2.² A specific example is the S. cerevisiae metabolic network. This network has 561 elements, with a power law exponent of 2.0, corresponding to a mean of 4.20 inputs per element.

Using yeast 2-hybrid methods on a genome wide scale, researchers at Curagen and Washington University have examined protein-protein interactions in yeast.¹ Using yeast 2-hybrid technology to detect in vivo protein-protein interactions, they estimated the mean connectivity for yeast to be between 1.8 and 3.3. Also, they found many examples of proteins that have far more interactions than the mean. Their data suggest that the yeast protein-protein network likely has a broad distribution of connectivity.

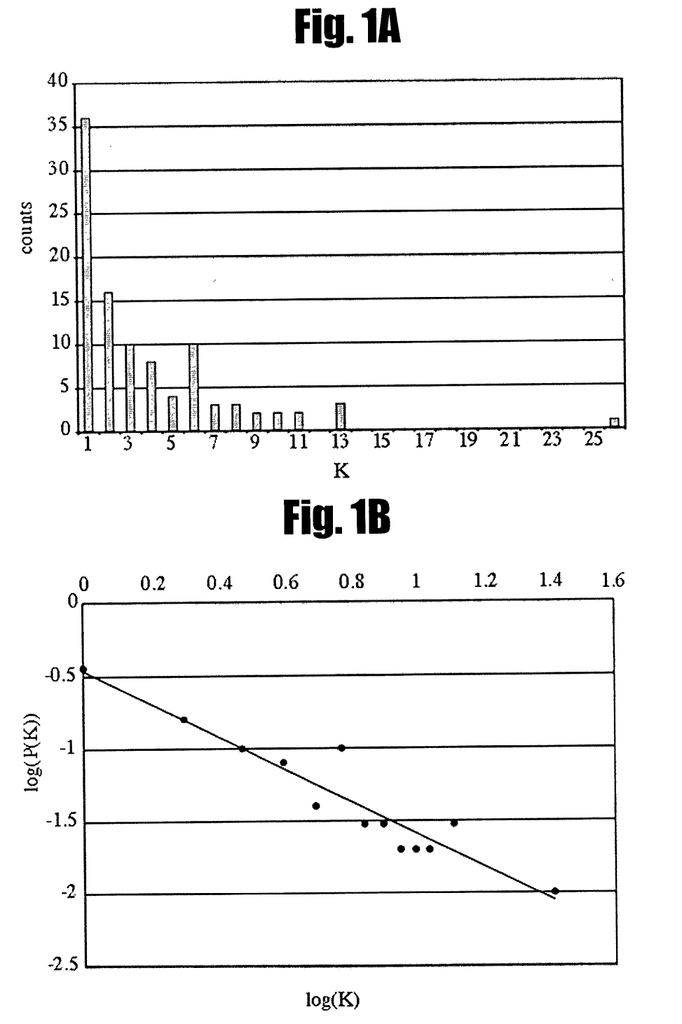

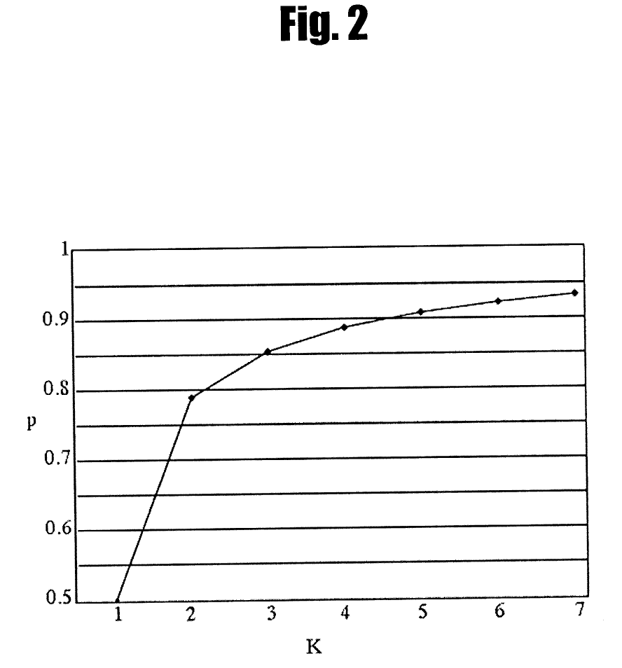

Finally, Kohn¹¹ has compiled a comprehensive map of known interactions in the mammalian cell cycle. Although the network and its topology are not completely known, the Kohn Map can provide a useful estimate of the distribution of connectivity in the mammalian cell cycle, which is known to have kicked-periodic dynamics under normal conditions of growth factor and hormone controlled cell division. To establish the connectivity of this network, we counted the number of inputs and outputs per protein and gene. FIG. 1A shows the histogram acquired from the Kohn Map. The total number of elements is 100, with a mean connectivity of 3.65. FIG. 1B illustrates the fitted power law of the distribution. The exponent is 1.12.

In the framework of Kauffman networks, the mean connectivities of these examples suggest that real biological networks should display “disordered” dynamics. The fact that biological networks display ordered dynamics forces the question of the origin of this order. Some have approached this question from the point of view of biases in interactions such as canalizing functions,¹² and internal homogeneity.¹² While this may account for the order of these systems, topology may also play a role. In particular, the assumption that biochemical networks have a fixed number of inputs has no biophysical basis and appears to be in contradiction to emerging experimental evidence.^{1,10,11} We expect that a distribution in the number of inputs K may affect the dynamics of biochemical networks and may be a source of the order observed in real cells.

Recently, the effects of topology on properties of very large networks have been studied in the context of complex systems. Watts and Strogatz¹³ investigated “small world” networks, showing that seemingly small changes in topology in locally connected networks can greatly affect global properties such as average distance between nodes in a network and the rate of information propagation. Scale-free networks, characterized by power law distribution in connectivity, have also been studied. Several examples of large networks that show scale-free organization have been found: the World Wide Web, social networks, and power grid nets,¹⁴ as well as the previously mentioned metabolic networks. Such networks are robust and error tolerant.¹⁵ Also, a mechanism has been suggested whereby such organization could naturally arise in a growing network.¹⁴ However, the effect that network topology may have on dynamics has not been addressed.

Motivated by experimental evidence just highlighted, we investigate how a distribution of the number of inputs per element affects the dynamics of biochemical networks. We investigate delta function, Poisson, and power law distributions in the framework of Boolean networks. We analytically show that the critical value of the interaction bias parameter, p, is independent of the distribution in the limit of the number of elements N [symbol] ∞. We also study these networks numerically using three different measures: types of attractors observed, fraction of active elements, and length of periodic orbits. We show that for finite networks below the critical point, a power law distribution produces networks that are more ordered than either the Poisson or delta function distributions. These results suggest that the recently characterized broad distribution in the number of inputs per element may provide a source of order in biochemical networks.

Definition of Model

The model that we study is a modification of the extensively studied Kauffman network.^{4,16-22} In this model, we allow each element of the network σᵢ to take on the values of 0 or 1. The i^{th} element receives input from Kᵢ other elements in the network. These Kᵢ inputs are chosen at random from the N elements. Self-inputs are allowed, but multiple inputs from the same element are not allowed. In our study, we choose K, from a distribution P(K), as opposed to the fixed K (delta function distribution) used in the original Kauffman model. P(K) is nonzero only for values of K between 1 and some cutoff Kₘₐₓ that should be equal to N, the number of elements in the network. However, due to restrictions on computer memory and time, we use Kₘₐₓ=30 if N is larger than 30.

To compute the time evolution of the system, the i^{th} element has an associated Boolean function, or rule table, Bi, which maps the state of all Kᵢ input elements to an output state of either 0 or 1. The fraction of “1” output states is designated as the biasing parameter p. Because of the symmetry of p around 0.5, we can choose 0.5≦p≦1.0. The evolution of the system takes place in discrete time steps. At each step, all N elements in the network are updated synchronously. Once the rule table and all the connectivities have been defined, we initialize each element in the network randomly, and then update the network synchronously for 500 time steps to allow transients to die off. We continue updating until we either hit an arbitrarily chosen cutoff or find a fixed or periodic state.

In general, Boolean networks will move into one of three different types of attractors.⁴ The system can fall into a fixed state, a periodic state, or a “disordered” state. A disordered state is characterized by periods that grow exponentially with N, the number of elements in the network. Thus for large N, these states appear to be non-repeating or aperiodic. Deciding how long a period must be to be termed disordered is arbitrary: there is no clear boundary between the periodic and disordered states. We choose a cutoff of 1500.

We characterize the dynamics of networks having three types of distribution functions P(K). In particular, we look at the following distributions:

1. The delta function distribution, where P(K) is nonzero only for K=Kₘₑₐₙ.

2. The Poisson distribution, given by

$$P ( K ) = \frac{{x}^{K} * {ⅇ}^{- x}}{K !} ,$$

with x=Kₘₑₐₙ. If the random value for Kᵢ chosen from this distribution is zero we assign Kᵢ=1, and if the value lies above Kₘₐₓ we set K₁=Kₘₐₓ.

3. A power law distribution given by P(K)=A*K^{β}, for 1≦K≦Kₘₐₓ. Here we chose the exponent β by picking the mean of the distribution to be equal to Kₘₑₐₙ. The coefficient A is determined by requiring P(K) to be normalized.

Results

First, we analytically study an order parameter of these networks: the fraction of elements in a network that remains active after an initial transient. Studying this order parameter allows us to make predictions about the location of the critical point. At this point the network goes from a frozen state to one with a finite fraction of active elements. We also study the system numerically using three different measures. We first classify the types of attractors as a function of bias p and mean connectivity Kₘₑₐₙ. Next we characterize the networks in terms of the order parameter. Finally, we measure the lengths of periodic orbits. In all three measures, the power law networks show more order.

A. Analytical Results

First we look at the fraction u of the network that remains active after an initial transient. Previously, this quantity u=u(p,Kₘₑₐₙ) was studied in the original Kauffman network as a function of the bias p and the mean connectivity Kₘₑₐₙ. This quantity was first studied using an annealed approximation.^{17,18} Later, Flyvbjerg¹⁹ found an analytical expression for the critical value of p at which a network with a fixed connectivity for each element would undergo a phase transition from a totally frozen state to one where a finite fraction of the elements are active. This analysis was done in the limit as N [symbol] ∞ (the thermodynamic limit). This critical point is given by

$${p}_{crit} = \frac{1}{2} ( 1 + \sqrt{1 - \frac{2}{K}} )$$

We extend Flyvbjerg's analysis to the case where the connectivity of each element K₁ is chosen from a distribution P(K). We find a map that expresses how the “frozen component” grows during a time step as a function of its size at the previous time step. The frozen component at time t is defined as the fraction s(t) of elements in the network that do not change after time t. Thus we are looking for a map F(s) such that s(t+1)=F(s(t)). We look at a specific element with K inputs. There are in general K+1 ways for this element to be engulfed by the frozen component. We write down these probabilities and then sum all K+1 terms to find the total probability that an element will become frozen. For example, the “zeroth” way for this to occur is if all K inputs to the element are frozen. The probability of this occurring is given by

$${\sum }_{K = 1}^{∞} {s}^{K} P ( K ) ,$$

where P(K) is again the distribution of inputs. The appendix shows the complete calculation.

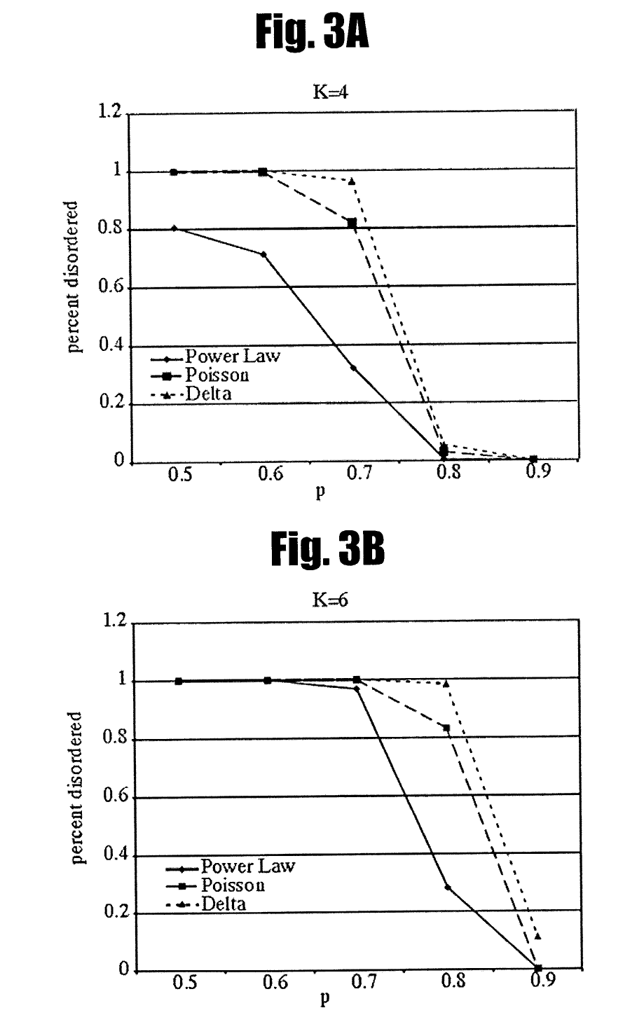

The final result is given by

$${p}_{crit} = \frac{1}{2} ( 1 + \sqrt{1 - \frac{2}{{K}_{mean}}} )$$

where Kₘₑₐₙ is the mean value of K. In the thermodynamic limit, the only quantity the critical point depends on is the average value of K. FIG. 2 shows a plot of the critical point as a function of the Kₘₑₐₙ.

B. Numerical Results

We ran simulations of networks with N=100 using three different distributions P(K): a delta function, a Poisson distribution, and a power law, as discussed previously. All data were averaged over 500 trials, each with a different network realization and one initial condition per network. These simulations were written in C23 and run on Sun workstations and Apple Macintosh G3 processors. We calculated several quantities (after an initial transient of 500 time steps) as a function of the bias p for Kₘₑₐₙ=2, 4, 6.

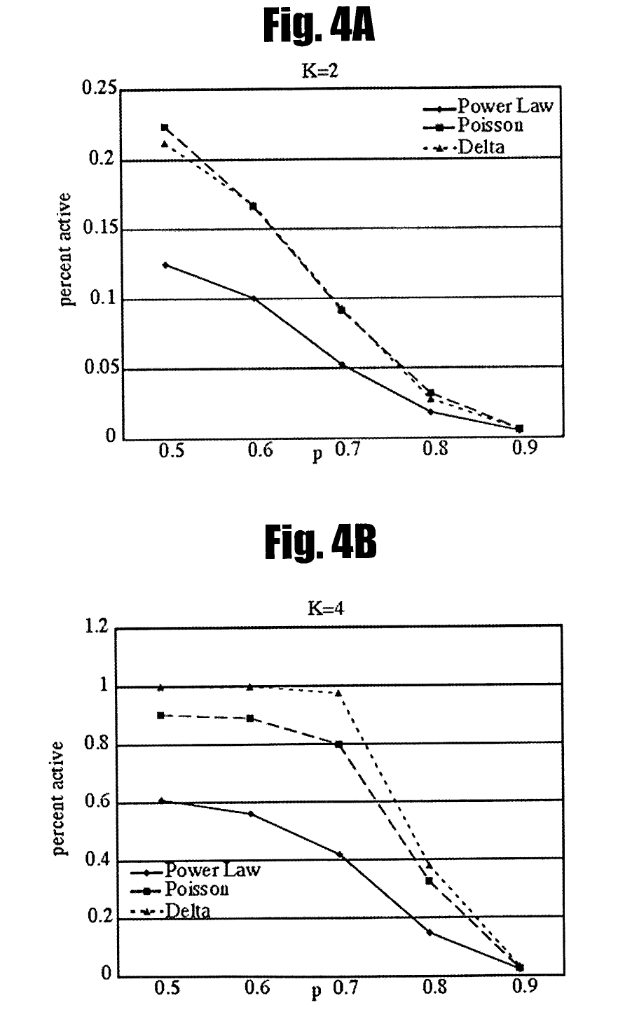

Attractor classification: We first studied the types of attractors that exist for these networks as a function of p and Kₘₑₐₙ. We measured the fraction of networks that become fixed, periodic, and disordered, for all three distributions. FIGS. 3A and 3B shows the fraction of disordered networks as a function of p for Kₘₑₐₙ=4 and Kₘₑₐₙ=6, respectively. Comparing FIGS. 3A and 3B to FIG. 2 we see that the transition between a zero and nonzero fraction of disordered networks is in good agreement with the theoretically obtained critical point. We also note that in the regime where a significant fraction of networks are disordered, the power law networks show considerably more order. This is particularly apparent for the Kₘₑₐₙ=4 graph, in which the power law nets clearly have a larger fraction of periodic solutions.

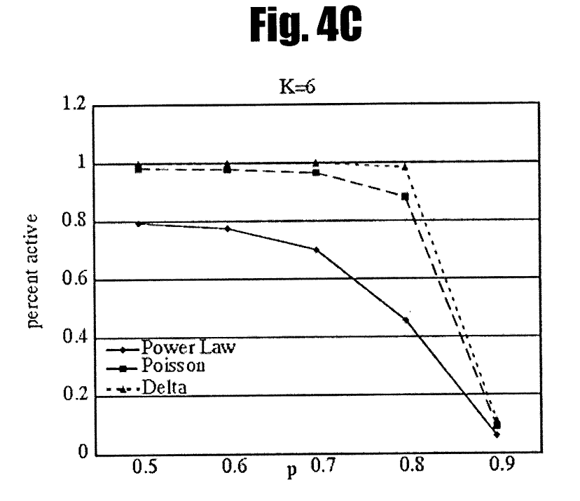

Fraction of active elements: FIGS. 4A through 4C show the fraction of active elements as a function of p for three values of Kₘₑₐₙ. We mention that if fixed and periodic behavior can occur for the same value of p and Kₘₑₐₙ, we see large error bars (which we leave off in the interest of clarity) on the fraction of active elements in a network. For example, at Kₘₑₐₙ=2 and p=0.5, where both fixed and periodic solutions can occur, the error bars extend from 0.0 to roughly 0.4. The fact that these attractors tend to coexist near the critical point makes it difficult to find the critical point numerically using this order parameter for finite values of N. However, the rough position seems to be in good agreement with the theory. We note that the power law distributions produce a large fraction of frozen elements even for large Kₘₑₐₙ and a bias of 0.5. In contrast, the delta function networks have a steep increase in active elements below the critical point.

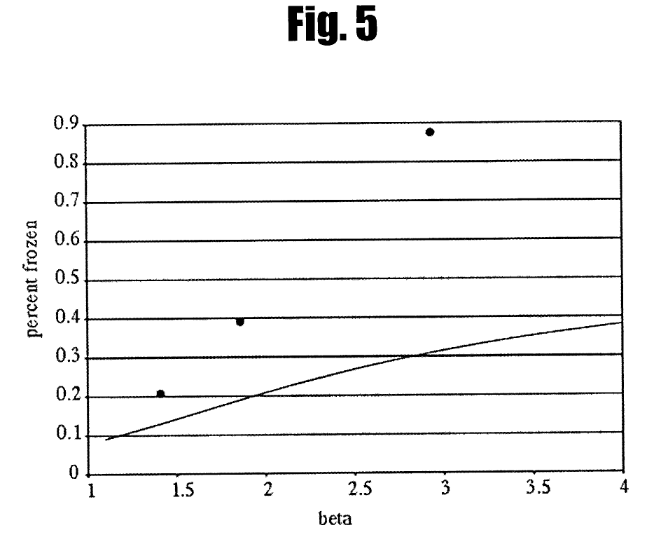

We can understand the large frozen component in the power law networks in the so called disordered regime by noting that even if Kₘₑₐₙ is large, a significant fraction of the elements in the network will have a value of K=1 or K=2. We can write an expression for the lower bound on the size of the frozen component by asking what fraction of the network will be frozen due to elements whose states are independent of their rule tables. This lower bound is given by

$${s}_{LB} = {\sum }_{K = 1}^{∞} P ( K ) * {p}_{K} ,$$

where P(K) is the distribution of inputs K, and p_{K} is the probability of an element being independent of all K of its inputs. We can analytically compute this lower bound for the power law distribution as a function of the exponent β. As Kₘₑₐₙ becomes large, we expect the actual steady state fraction of frozen elements to approach this lower bound. FIG. 5 illustrates this point.

Length of period: Finally, we measured the average period length of periodic networks as a function of the bias p for those values of p and Kₘₑₐₙ that produce periodic dynamics. We again observe that the networks with power law distributions appear more ordered than the Poisson and delta functions distributions. See Table 1, below. The delta function and Poisson networks have disordered dynamics at p=0.5 and 0.6. The power law networks have much shorter average periods in the periodic regime.

TABLE 1
Average Period for K = 4

| Bias p | 0.5 | 0.6 | 0.7 | 0.8 | 0.9 |
|---|---|---|---|---|---|
| Delta function | — | — | 388 | 53.2 | 3.54 |
| Poisson | — | — | 308 | 54.0 | 3.65 |
| Power law | 268 | 185 | 133 | 16.3 | 3.52 |

Discussion

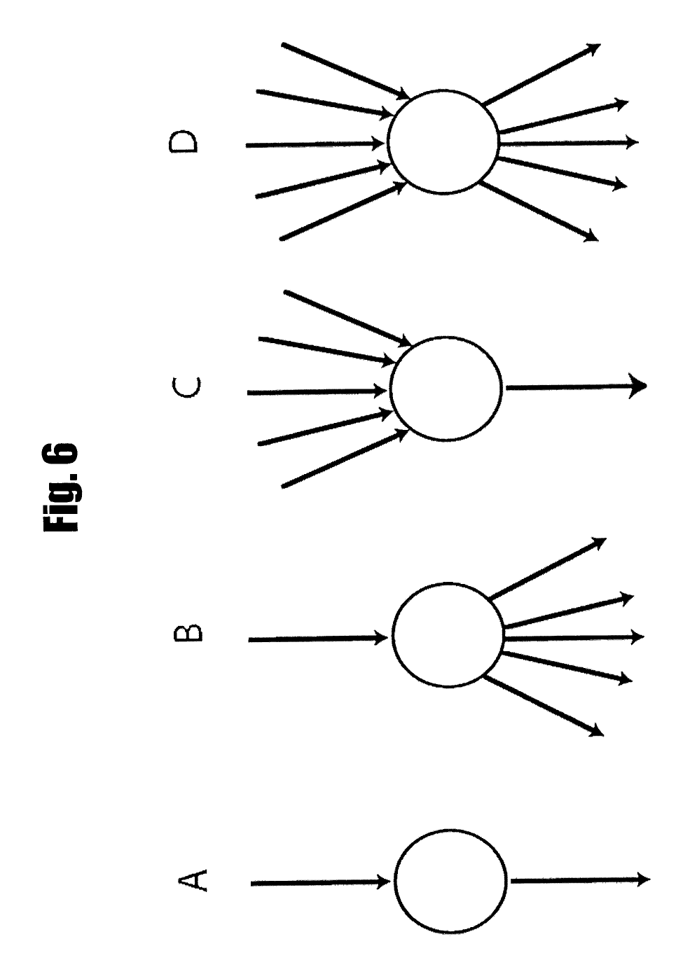

This study was done to investigate the relationship between topology and dynamics in biochemical networks. We have cited three pieces of recent experimental evidence that suggest that biochemical networks have broad distributions in the number of inputs and outputs. The possibility that these networks may have broad distributions has been suggested previously. For example, Somogyi and others²⁰ have proposed that multigenic (elements with many inputs and few outputs) and pleiotropic (elements with few inputs and many outputs) elements may be common and important organizational themes in real cellular networks. FIG. 6 schematically illustrates these two types of organizational themes, as well as two other types: “simple node” elements (few inputs and few outputs) and “super node” elements (many inputs and many outputs). The mammalian cell cycle provides several examples of these strategics.¹¹ RPaseII (8 inputs, 2 outputs) is a multigenic element; ATM (2 inputs, 5 outputs), is a pleiotropic element; Max (one input, one output) is a simple node, while p53 (26 inputs 14 outputs) is a super node. Similar examples can be found in gene regulation networks. For example, some transcription factors such as the zinc-finger protein Sp1 in mammals control the expression of more than 300 genes.²⁴ Others, such as the lac repressor in E. coli bacteria, control only a single gene.⁸ This variety of organizational strategies within a network is only possible if there is a broad distribution of connectivity.

Motivated by evidence for broad distributions in real biochemical networks, we studied Boolean networks with delta function, Poisson, and power law distributions in number of inputs to see how these topological modifications affect dynamics of the network. We first analytically showed that in the thermodynamic limit, the critical point does not change with the addition of the distribution in K. This calculation was done by extending the method of Flyvbjerg.¹⁹

We next studied finite delta function, Poisson, and power law networks numerically. We characterized these three types of networks using three different measures: type of attractors, fraction of active elements, and length of period. We measured these three quantities as a function of the interaction bias p and the average connectivity K. We found that for all three measures, the power law nets show considerably more order than the delta function networks that had been studied previously.

One plausible mechanism that may contribute to this ordered behavior is the following. The power law distribution not only is characterized by a heavy tail; it also produces values of K near 1 with high probability, even if the mean value of K is large. These elements with few inputs are much more likely to be frozen, and these frozen elements reduce the size of the network that is still active by a significant fraction. These elements effectively reduce the mean value of K for the network; even if a particular element has a large number of inputs, a significant fraction of those inputs will be frozen. For example, for K=4 and p=0.7, we measured the effective mean K (the average number of active inputs to active elements) for all three distributions. We found that the delta function, Poisson, and power law distributions had effective mean values of K of 3.0, 2.7, and 2.1. Thus, the order that is introduced by a large number of small K elements may outweigh the disorder produced by a few elements with very large K.

Our numerical studies show that finite networks with broad, scale-free distributions in connectivity can show more order than networks with sharply peaked distributions. For a given number of elements N and a given mean connectivity Kₘₑₐₙ, a network randomly selected using a scale-free distribution of K is more likely to be ordered than one selected using a tight distribution. Perhaps this fact is one reason why real biological networks exhibit broad distributions in connectivity.

Derivation of Critical Point

For a distribution of inputs P(K), the “zeroth” way for an element to become frozen is if all K inputs are frozen. This probability is given by

$${\sum }_{K = 1}^{∞} {S}^{K} P ( K ) .$$

The next way for an element to become frozen is if all but one of the inputs are frozen and if the state of this element is independent of the remaining active element. The probability of this occurring is given by

$${\sum }_{K = 1}^{∞} K * {s}^{K - 1} ( 1 - s ) {p}_{1} P ( K ) ,$$

where p₁ is the probability that an element with one input is independent of that input. In general, pₖ is defined as the probability that an element with k inputs is independent of all k inputs. This probability will depend on the bias of the network.

We can continue to write down these terms using similar reasoning. Thus the kth term in the sum will be given by

$${\sum }_{K = 1}^{∞} ( \frac{K !}{k ! ( K - k ) !} ) * {( {s}^{K - k} ( 1 - s ) )}^{k} {p}_{k} P ( K ) ,$$

where P₀ is defined to be 1.

Summing all K+1 terms gives us:

$$s ( t + 1 ) = {\sum }_{K = 1}^{∞} {\sum }_{k = 0}^{K} ( \frac{K !}{k ! ( K - k ) !} ) * {{s}^{K - k} ( 1 - s )}^{k} {p}_{k} P ( K ) \qquad ( 1 )$$

This is the expression of the return map. Now we let u=1−s, where u is the fraction of elements that are unfrozen. Then we have:

$$u ( t + 1 ) = 1 {- \sum }_{K = 1}^{∞} {\sum }_{k = 0}^{K} ( \frac{K !}{k ! ( K - k ) !} ) * {( 1 - u )}^{K - k} {u}^{k} {p}_{k} P ( K ) \qquad ( 2 )$$

Clearly u=u*=0 is a fixed point. Now we expand around this fixed point to study its stability. To find the critical point, we look at when this fixed point will go unstable.

Let u=u*+δ with δ a small number. Then we can rewrite equation (2), keeping only the zeroth and first order terms. The k=0 term in the sum provides one zeroth order term and one first order term. The k=1 term in the sum provides one first order term. Adding these we have:

$$δ ( t + 1 ) = 1 - \{ 1 + {\sum }_{K = 1}^{∞} - K * δ * {p}_{0} * P ( K ) + {\sum }_{K = 1}^{∞} K * δ * {p}_{1} * P ( K ) \} \qquad ( 3 )$$

Now, we know p₀=1, so we must determine p₁. Recall that p₁ is the probability that an element is independent of its only active input. If all but one input to an element are frozen, then the effective rule table for that element has only two entries, one for each state of the input element. For the state of the element to be independent of the input, we need both of these entries in its rule table to have the same value. This occurs with probability p²+(1−p)², where p is the bias of the network.

We can now write:

$$δ ( t + 1 ) = δ * ( {\sum }_{K = 1}^{∞} KP ( K ) - {p}_{1} {\sum }_{K = 1}^{∞} KP ( K ) ) \\ or \\ δ ( t + 1 ) = δ * ( ⟨ K ⟩ - {p}_{1} ⟨ K ⟩ ) = δ * ⟨ K ⟩ ( 1 - {p}^{2} + {( 1 - p )}^{2} ) \qquad ( 4 )$$

The fixed point goes unstable when the coefficient of the linear term has absolute value larger than 1. This occurs at:

$${P}_{crit} = \frac{1}{2} ( 1 + \sqrt{1 - \frac{2}{{K}_{mean}}} ) \qquad ( 5 )$$

Additional Caption Information for FIGS. 1-6

FIG. 1A: This figure shows the histogram for the mammalian cell cycle obtained from the Kohn Map.¹² Inputs to an element were defined as other elements that modified the behavior of the first element. Outputs were elements whose behavior was modified by the first element. We counted a total of 100 elements with at least one input in the Kohn Map.

FIG 1B: The dots are the data of FIG. 1A plotted in log-log format. The line is the fitted power law distribution for the network. The exponent is 1.12.

FIG. 2: This figure shows the theoretically obtained critical value of the bias p as a function of the mean number of inputs Kₘₑₐₙ. In the N [symbol] ∞, networks with values of p above the critical value would have only frozen elements.

FIG. 3: This figure shows the fraction of disordered (period>1500) nets as a function of p for K=4 (FIG. 3A) and 6 (FIG. 3B) and N=100. For K=2, nearly all nets are ordered for any p. Note that for K=4, far fewer power law nets are disordered.

FIG. 4: This figure shows the fraction of active, or unfrozen, elements in a network as a function of bias p for K=2, 4, and 6 and N=100, in FIGS. 4A, 4B, and 4C, respectively. Note the significant fraction of frozen elements in the power law nets for p=0.5 and K=4 and K=6.

FIG. 5: This figure shows the lower bound of the fraction of frozen elements in power law nets as a function of the exponent beta in the power law with a bias p=0.5. This lower bound is found by considering how many elements will be independent of all K inputs. For comparison, we place a dot at the values of beta that correspond to the three values of Kₘₑₐₙ that we use in our simulations. For Kₘₑₐₙ=2, the frozen component is significantly larger than the lower bound, but as Kₘₑₐₙ increases (β decreases), the frozen component remains closer to the lower bound.

FIG. 6: This is a schematic of the four types of organizations:

A. “Simple node”—A node with few inputs and few outputs. Max is an example from the Kohn Map.

B. “Pleiotropic node”—A node with few inputs and many outputs. ATM is an example from the Kohn Map.

C. “Multigenic node”—A node with many inputs and few outputs. RPaseII is an example from the Kohn Map.

D. “Super node”—A node with many inputs and many outputs. p53 is an example from the Kohn Map.

### REFERENCES

The following references, cited by superscripted numbers above, are hereby incorporated herein by reference in their entireties.

1. P. Uetz, L. Giot, G. Cagney, T. A. Mansfield, R. S. Judson, J. R. Knight, D. Lockshon, V. Narayan, M. Srinivasan, P. Pochart, A. Qureshi-Emili, Y. Li, B. Godwin, D. Conover, T. Kalbfleisch, G. Vijayadamodar, M. Yang, M. Johnston, S. Fields, J. M. Rothberg, “A comprehensive analysis of protein-protein interactions in Saccharomyces cerevisiae,” Nature 403, 623 (2000).

2. S. Tavazoie and G. M. Church, “Quantitative whole-genome analysis of DNA-protein interactions by in vivo methylase protection in E. coli,” Nat. Biotechnol. 16, 566 (1998).

3. S. Kauffman, M. Ballivet, Cistem Molecular Corporation, U.S. Pat. No. 6,100,035 (2000).

4. S. A. Kauffman, “Metabolic stability and epigenesis in randomly connected nets,” J. Theor. Biol. 22, 437 (1969).

5. L. Glass, “Classification of biological networks by their qualitative dynamics,” J. Theor. Biol. 54, 85 (1975).

6. R. J. Bagley and L. Glass, “Counting and classifying attractors in high dimensional dynamical systems,” J. Theor. Biol. 183, 269 (1996).

7. L. Glass and C. Hill, “Ordered and disordered dynamics in random networks,” Europhys. Lett. 41, 599 (1998).

8. F. Jacob and J. Monod, “On the regulation of gene activity,” In Cold Spring Harbor Symposia on Quantitative Biology, vol. 26 (Cold Spring Harbor Laboratory, Cold Spring Harbor, N.Y., 1961).

9. A. Goldbeter, Biochemical Oscillations and Cellular Rhythms (Cambridge University Press, Cambridge, 1996).

10. H. Jeong, B. Tombor, R. Albert, Z. N. Oltvai, and A.-L. Barabasi, “The large-scale organization of metabolic networks,” Nature 407, 651 (2000).

11. K. Kohn, “Molecular Interaction Map of the Mammalian Cell Cycle Control and DNA Repair Systems,” Molecular Biology of the Cell 10, 2703 (1999).

12. S. A. Kauffman, Origins of Order (Oxford University Press, Oxford, 1993).

13. D. J. Watts and S. H. Strogatz, “Collective dynamics of ‘small world’ networks,” Nature 393, 440 (1998).

14. A.-L. Barabasi and R. Albert, “Emergence of scaling in random networks,” Science 286, 509 (1999).

15. R. Albert, H. Jeong, and A.-L. Barabasi, “Error and attack tolerance of complex networks,” Nature 406, 378 (2000).

16. S. A. Kauffman, “The large scale structure and dynamics of gene control circuits: an ensemble approach,” J. Theor. Biol. 44, 167 (1974).

17. B. Derrida and Y. Pomeau, “Random networks of automata: a simple annealed approximation,” Europhys. Lett. 1, 45 (1986).

18. B. Derrida and D. Stauffer, “Phase transition in two-dimensional Kauffman cellular automata,” Europhys. Lett. 2, 739 (1986).

19. H. Flyvbjerg, “An order parameter for networks of automata,” J. Phys. A: Math. Gen. 21, L955 (1988).

20. R. Somogyi and C. Sniegoski, “Modeling the complexity of genetic networks: understanding multigenic and pleiotropic regulation,” Complexity 1, 45 (1996).

21. B. Luque and R. Sole, “Phase transitions in random networks: simple analytic determination of critical points,” Phys. Rev. E 55, 257 (1997).

22. R. Albert and A.-L. Barabasi, “Dynamics of complex systems: scaling laws for the period of Boolean networks,” Phys. Rev. Lett. 84, 5660 (2000).

23. W. H. Press, S. A. Teukolsky, W. T. Vetterling, and B. P. Flannery, Numerical Recipes in C, 2nd ed. (Cambridge University Press, 1992).

24. J. Zuber, O. I. Tchernitsa, B. Hinzmann, A. C. Schmitz, M. Grips, M. Hellriegel, C. Sers, A. Rosenthal, and R. Schafer, “A genome-wide survey of RAS transformation targets,” Nat. Genet. 24, 144 (2000).

Alternate Embodiments

The order in which the steps of the present method are performed is purely illustrative in nature. In fact, the steps can be performed in any order or in parallel, unless otherwise indicated by the present disclosure.

The method of the present invention may be performed in either hardware, software, or any combination thereof, as those terms are currently known in the art. In particular, the present method may be carried out by software, firmware, or microcode operating on a computer or computers of any type. Additionally, software embodying the present invention may comprise computer instructions in any form (e.g., source code, object code, interpreted code, etc.) stored in any computer-readable medium (e.g., ROM, RAM, magnetic media, punched tape or card, compact disc (CD) in any form, DVD, etc.). Furthermore, such software may also be in the form of a computer data signal embodied in a carrier wave, such as that found within the well-known Web pages transferred among devices connected to the Internet. Accordingly, the present invention is not limited to any particular platform, unless specifically stated otherwise in the present disclosure.

While particular embodiments of the present invention have been shown and described, it will be apparent to those skilled in the art that changes and modifications may be made without departing from this invention in its broader aspect and, therefore, the appended claims are to encompass within their scope all such changes and modifications as fall within the true spirit of this invention.

We claim:

1. A method of inferring a network model of a process, comprising:
generating a search space of candidate networks;
reducing said search space by eliminating one or more non-fitting candidate networks to form a reduced search space;
testing said candidate networks in said reduced search space against one or more criteria to identify an ensemble of networks; and
modeling said process using said ensemble of networks.

2. The method of claim 1, wherein said reducing further comprises:
identifying one or more scale-free candidate networks in said search space; and
classifying all non-scale-free candidate networks as non-fitting candidate networks based on said identifying.

3. The method of claim 1, wherein said process is a biologic process.

4. The method of claim 1, wherein said ensemble of networks is a Bayesian ensemble.

5. An apparatus for inferring a network model of a process, comprising:
means for generating a search space of candidate networks;
means for reducing said search space by eliminating one or more non-fitting candidate networks to form a reduced search space;
computer means for testing said candidate networks in said reduced search space against one or more criteria to identify an ensemble of networks; and
computer means for modeling said process using said ensemble of networks.

6. The apparatus of claim 5, wherein said reducing means further comprises:
means for identifying one or more scale-free candidate networks in said search space; and
means for classifying all non-scale-free candidate networks as non-fitting candidate networks based on said identifying.

7. The apparatus of claim 5, wherein said process is a biologic process.

8. The apparatus of claim 5, wherein said ensemble of networks is a Bayesian ensemble.

9. A computer system for use in inferring a network model of a process, comprising computer instructions for:
generating a search space of candidate networks;
reducing said search space by eliminating one or more non-fitting candidate networks to form a reduced search space;
testing said candidate networks in said reduced search space against one or more criteria to identify an ensemble of networks; and
modeling said process using said ensemble of networks.

10. The computer system of claim 9, wherein said computer instructions for reducing further comprise computer instructions for:
identifying one or more scale-free candidate networks in said search space; and
classifying all non-scale-free candidate networks as non-fitting candidate networks based on said identifying.

11. The computer system of claim 9, wherein said process is a biologic process.

12. The computer system of claim 9, wherein said ensemble of networks is a Bayesian ensemble.

13. A computer-readable medium storing a computer program executable by a plurality of server computers, the computer program comprising computer instructions for:
generating a search space of candidate networks;
reducing said search space by eliminating one or more non-fitting candidate networks to form a reduced search space;
testing said candidate networks in said reduced search space against one or more criteria to identify an ensemble of networks; and
modeling said process using said ensemble of networks.

14. The computer-readable medium of claim 13, wherein said computer instructions for reducing further comprise computer instructions for:
identifying one or more scale-free candidate networks in said search space; and
classifying all non-scale-free candidate networks as non-fitting candidate networks based on said identifying.

15. The computer-readable medium of claim 13, wherein said process is a biologic process.

16. The computer-readable medium of claim 13, wherein said ensemble of networks is a Bayesian ensemble.

17. A computer data signal embodied in a carrier wave, comprising computer instructions for:
generating a search space of candidate networks;
reducing said search space by eliminating one or more non-fitting candidate networks to form a reduced search space;
testing said candidate networks in said reduced search space against one or more criteria to identify an ensemble of networks; and
modeling said process using said ensemble of networks.

18. The computer data signal of claim 17, wherein said computer instructions for reducing further comprise computer instructions for:
identifying one or more scale-free candidate networks in said search space; and
classifying all non-scale-free candidate networks as non-fitting candidate networks based on said identifying.

19. The computer data signal of claim 17, wherein said process is a biologic process.

20. The computer data signal of claim 17, wherein said ensemble of networks is a Bayesian ensemble.
